(19) United States
(12) Patent Application Publication
(10) Pub. No.: US 2007/0142047 A1
(43) Pub. Date: Jun. 21, 2007

(54) METHOD AND APPARATUS FOR MANAGING INCOMING CALLS USING DIFFERENT VOICE SERVICES ON A MULTI-MODE WIRELESS DEVICE

(75) Inventors: David R. Heeschen, Coral Springs, FL (US); Jean Khawand, Miami, FL (US); Mitchell E. Renko, Coral Springs, FL (US)

Correspondence Address: FLEIT, KAIN, GIBBONS, GUTMAN, BONGINI;& BIANCO P.L., 551 N.W. 77TH STREET, SUITE 111, BOCA RATON, FL, 33487, US

(73) Assignee: MOTOROLA, INC., SCHAUMBURG, IL (US)

(21) Appl. No.: 11/311,954

(22) Filed: Dec. 19, 2005

(51) Int. Cl. H04Q 7/20

(52) U.S. Cl. 455/435.1

(57) ABSTRACT

A device and method for receiving communications associated with a second communication service while actively communicating using a first communication service is disclosed. The method includes receiving an incoming call associated with a second communication service at a wireless device (104). The second communication service is either different than the first communication service currently being used by the wireless device (104) or is a similar communication service using a different network than the first communication service. The method also includes notifying a user of the wireless device (104) of the incoming call associated with the second communication service.

### CROSS-REFERENCE TO RELATED APPLICATION

Not Applicable

1. Field of the Invention

The present invention generally relates to the field of wireless communications devices, and more particularly relates to multi-mode wireless communication devices.

2. Background of the Invention

In the present day, wireless communication devices such as cellular phones are capable of transmitting/receiving multiple communication services such as push-to-talk (“PTT”) communications, cellular communications, and data communications. For example, multi-mode devices using a multi-mode network can make both PTT and cellular calls. PTT is a method of conversing over half-duplex communication lines, including two-way radio, by pushing a button to send a transmission and releasing the button to receive a transmission back. In other words, PTT allows a wireless communication device to operate as a two-way radio when in the PTT mode. Only one PTT

More recently, push-to-talk over cellular (“PoC”) has become available to users of these multi-mode wireless communication devices. PoC is a wireless feature that allows wireless service subscribers to make direct, simultaneous radio voice connections over any packet data network. PoC is implemented on the IP back-bone, which allows any packet data service to provide PoC communications.

Although multi-mode wireless devices allow for a variety of useful and different types of communication options, these multi-mode wireless devices have numerous drawbacks, problems, and shortcomings.

One problem is that while a multi-mode wireless device is actively engaged in one communication service such as a cellular call, the multi-mode wireless device cannot manage incoming calls from other communication services such as PTT. For example, if the multi-mode wireless device is camped on two networks at the same time (multi-camped) that offer two different communication services or camped on a single network offering two different communication services, if the user is actively in a PTT call, an incoming cellular call is not presented to the user. The incoming phone call, for example, is routed to the voice mail of the multi-mode wireless device or is ignored. The user of the multi-mode wireless device is never notified of the incoming phone call. The above problems also arise when the user is on a phone call and another user is trying to reach the user by PTT or PoC.

Therefore a need exists to overcome the problems with the prior art as discussed above.

### SUMMARY OF THE INVENTION

Briefly, in accordance with the present invention, disclosed are a method and device for receiving communications associated with a second communication service while actively communicating using a first communication service. The method includes receiving an incoming call associated with a second communication service at a wireless device. The second voice service is one of a different communication service than a first communication service currently being used by the wireless device or a similar communication service using a different network than the first communication service. The method also includes notifying a user of the wireless device of the incoming call associated with the second communication service.

In yet another embodiment of the present invention, a wireless device for receiving communications associated with a second communication service while actively communicating using a first communication service is disclosed. The wireless device comprises a memory and a device controller electrically coupled to the memory. The wireless device also includes at least one receiver for receiving a first communication associated with a first communication service and second communication associated with a second communication service. A multi-mode communications manager that is communicatively coupled to the device controller for managing an incoming communication associated with the first communication service while a user is actively using a second communication service is also included.

The multi-mode call manager comprises an incoming communication identifier. The incoming communication identifier identifies the incoming communication associated with the second communication service when the user is actively using the first communication service. The multi-mode call manager also includes a notifier for notifying the user of the incoming communication associated with the second communication service when the user is actively using the first communication service.

An advantage of the foregoing embodiments of the present invention is that a user of a multi-mode wireless device is informed of an incoming call associated with a communication service that is either different than the communication service currently in use by the multi-mode wireless device or that is using a different network. The user can then decide to accept the incoming call or perform other actions.

### BRIEF DESCRIPTION OF THE DRAWINGS

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram illustrating a wireless communication system, according to an embodiment of the present invention;

FIG. 2 is a block diagram illustrating a multi-mode wireless device for a wireless communication system according to an embodiment of the present invention;

FIG. 3 is a more detailed view of an exemplary multi-mode call manager, according to an embodiment of the present invention.

FIG. 4 is an exemplary operational flow diagram illustrating a process of managing an incoming call associated with a second communication service while actively communicating using a first communication service, according to an embodiment of the present invention.

FIG. 5 is an exemplary operational flow diagram illustrating a more detailed process of managing an incoming call associated with a second communication service while actively communicating using a first communication service illustrated in FIG. 4, according to an embodiment of the present invention.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

The present invention, according to an embodiment, overcomes problems with the prior art by notifying a user of a multi-mode wireless device of an incoming call associated with a second communication service while actively communicating using a first communication service. The user can then decide to perform a desired action on the incoming call.

The term wireless device is intended to broadly cover many different types of devices that can wirelessly receive signals, and optionally can wirelessly transmit signals, and may also operate in a wireless communication system. For example, and not for any limitation, a wireless device can include any one or a combination of the following: a cellular telephone, a mobile phone, a smartphone, a two-way radio, a two-way pager, a wireless messaging device, and the like. A multi-mode or multi-mode wireless is intended to broadly cover any wireless device that can communicate using more than one communication service such as PTT/PoC, cellular, Voice Over IP (“VoIP”), data packet transfer, or the same type of communication service but on different networks.

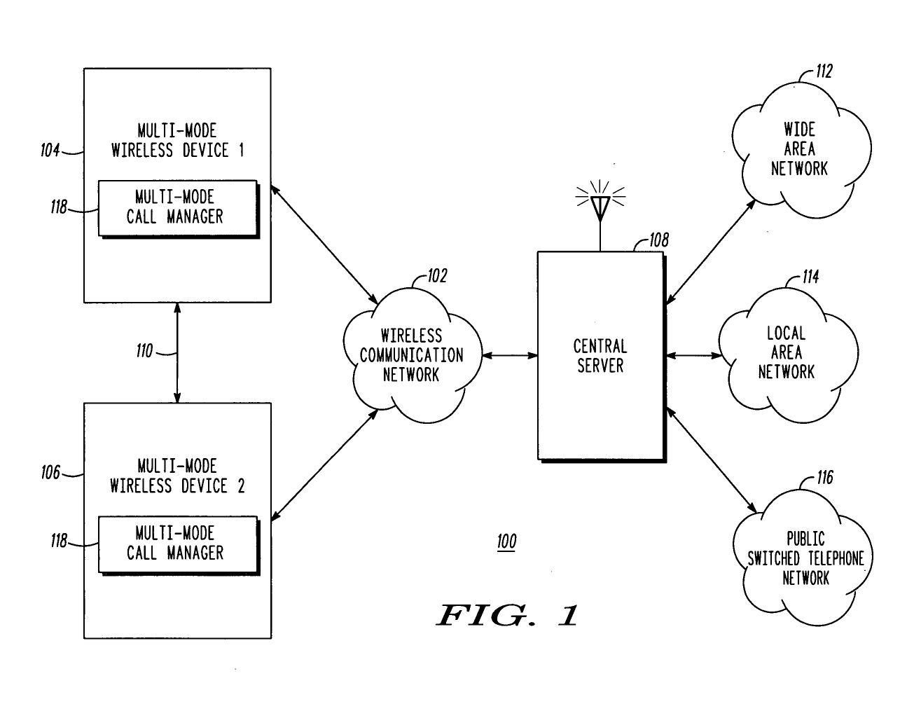

According to an embodiment of the present invention, as shown in FIG. 1, an exemplary wireless communications system 100 is illustrated. FIG. 1 shows a wireless communications network 102, that connects wireless devices such as multi-mode wireless devices 104, 106 and single-mode wireless devices (not shown) with a central server 108. The wireless network 102 comprises a mobile phone network, a mobile text messaging device network, a pager network, or the like. Further, the communications standard of the wireless network 102 of FIG. 1 comprises Code Division Multiple Access (CDMA), Time Division Multiple Access (TDMA), Global System for Mobile Communications (GSM), General Packet Radio Service (GPRS), Frequency Division Multiple Access (FDMA) or the like. Additionally, the wireless communications network 102 also comprises text messaging standards, for example, Short Message Service (SMS), Enhanced Messaging Service (EMS), Multimedia Messaging Service (MMS), or the like. The wireless communications network 102 also allows for PoC communications between the two multi-mode wireless devices 104, 106.

The wireless network 102 supports any number of multi-mode wireless devices 104, 106 and single-mode wireless devices (not shown). The support of the wireless network 102 includes support for mobile telephones, smart phones, text messaging devices, handheld computers, pagers, beepers, or the like. A smart phone is a combination of 1) a pocket PC, handheld PC, palm top PC, or Personal Digital Assistant (PDA), and 2) a mobile telephone. More generally, a smartphone can be a mobile telephone that has additional application processing capabilities.

Additionally, the multi-mode wireless devices 104, 106 also include a local wireless link 110 that allows the wireless devices 104, 106 to directly communicate with each other or with other multi-mode and single-mode wireless devices without using the wireless network 102. The local wireless link 110, for example, is provided by Mototalk for allowing PTT communications. The local wireless link 110, in another embodiment, is provided by Bluetooth, Infrared Data Access (IrDA) technologies or the like. The multi-mode wireless devices 104, 106 also include multi-mode call managers 118, 120 for managing incoming calls using a second communication service while the multi-mode wireless device 104, 106 is in an active call using a first communication service. The term incoming call used throughout this disclosure refers to, unless otherwise stated, an incoming call associated with a different communication service than what is currently being used by multi-mode wireless device. The multi-mode wireless devices 104, 106 and the multi-mode call managers 118, 120 are described in greater detail below.

The central server 108 maintains and processes information for all wireless devices such as the multi-mode wireless devices 104, 106 communicating on the wireless network 102. Additionally, the central server 108, in this example, communicatively couples the multi-mode wireless devices 104, 106 and single-mode wireless devices (not shown) to a wide area network 112, a local area network 114, and a public switched telephone network 116 through the wireless communications network 102. Each of these networks 112, 114, 116 has the capability of sending data, for example, a multimedia text message to the wireless devices 104, 106.

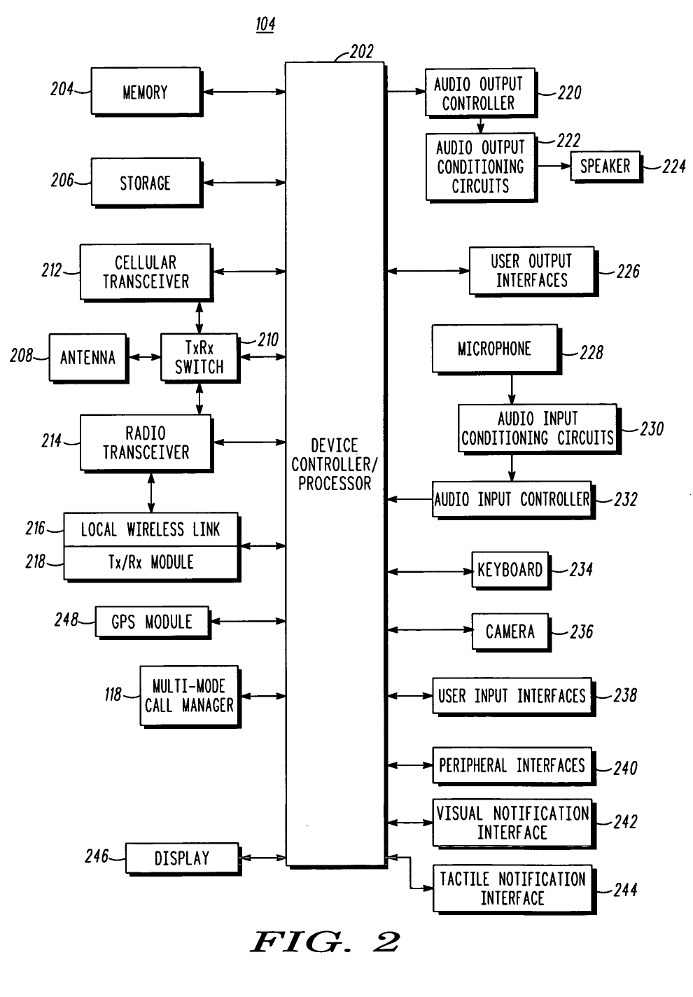

Referring to FIG. 2, a more detailed view of the multi-mode wireless device 104 is illustrated. The multi-mode wireless device 104 operates under the control of a device controller/processor 202, that switches the multi-mode wireless device 104 between receive and transmit modes. For example, the multi-mode wireless device 104 can be either in at least a first communication service mode or a second communication service mode. A first communication service, in one embodiment, is a PTT/PoC mode and a second communication service, in one embodiment, is a full-duplex mode such as a cellular mode or vice-versa. Throughout this disclosure, cellular mode is defined as being in a mode where normal full-duplex calls are made and not PTT or PoC calls. In another embodiment, a communication service is a data communication service such as a data packet transfer service or any other type of data communication as would be well known to one of ordinary skill in the art.

In a cellular receive mode, the device controller 202 electrically couples an antenna 208 through a transmit/receive switch 210 to a cellular transceiver 212. The cellular transceiver 212 decodes the received signals and provides those decoded signals to the device controller 202. In a cellular transmit mode, the device controller 202 electrically couples the antenna 208, through the transmit/receive switch 210, to the cellular transceiver 212. The device controller 202 operates the transceiver 212 according to instructions stored in the memory 204. These instructions include, for example, a neighbor cell measurement-scheduling algorithm.

In a PTT/PoC receive mode the device controller 202 electrically couples an antenna 208 through a transmit/receive switch 210 to a radio transceiver 214. The radio transceiver 214 decodes the received signals and provides those decoded signals to the device controller 202. In a PTT/PoC transmit mode, the device controller 202 electrically couples the antenna 208, through the transmit/receive switch 210, to the radio transceiver 214. The device controller 202 operates the radio transceiver 214 accordingly. In another embodiment, the cellular transceiver 212 and the radio transceiver 214 are a single component.

The multi-mode wireless device 104 also includes a multi-mode call manager 118. The multi-mode call manager 118 is electrically coupled to the cellular transceiver 212, the radio transceiver 214, and the device controller 202. The multi-mode call manager 118 is activated when the user of the multi-mode device 104 places a call or receives a call (when active in a call). An incoming call using a different communication service than the communication service currently in use by the multi-mode wireless device 104 is identified by the multi-mode call manager 118. Alternatively, the multi-mode manager 118 identifies two identical communication services that are using two different networks. The multi-mode call manager 118 notifies the user of the incoming call and presents options to the user or performs predefined tasks. The multi-mode call manager 118 in one embodiment is a hardware component in the multi-mode wireless device 104 and in another embodiment is a software component residing in the memory 204. The multi-mode call manager 118 will be discussed in greater detail below.

FIG. 2 also includes non-volatile storage memory 206 for storing, for example, an application waiting to be executed (not shown) on the multi-mode wireless device 104. In an another embodiment, the storage memory 206 also stores a set of rules for managing an incoming communication service while currently active in another communication service. The multi-mode wireless device 104, in this example, also includes a local wireless link 216 that allows the multi-mode wireless device 104 to directly communicate with another multi-mode wireless device 106 or a single-mode wireless device (not shown) without using the wireless network 102. When PTT or PoC is used to contact another multi-mode wireless unit, the local wireless link 216, for example, is provided by Mototalk and the radio transceiver 214 works in conjunction with the local wireless link 216. The local wireless link 216 includes a local wireless link transmit/receive module 218 that allows the multi-mode wireless device 104 to directly communicate with another multi-mode wireless device 106 or single subscriber wireless device by Bluetooth, Infrared Data Access (IrDA) technologies, or the like.

The multi-mode wireless device 104 of FIG. 2 further includes an audio output controller 220 that receives decoded audio output signals from the cellular transceiver 212, the radio transceiver 214, the local wireless link transmit/receive module 218. The audio controller 220 sends the received decoded audio signals to the audio output conditioning circuits 222 that perform various conditioning functions. For example, the audio output conditioning circuits 222 may reduce noise or amplify the signal. A speaker 224 receives the conditioned audio signals and allows audio output for listening by a user. The multi-mode wireless device 104 further includes additional user output interfaces 226, for example, a head phone jack (not shown) or a hands-free speaker (not shown).

The multi-mode wireless device 104 also includes a microphone 228 for allowing a user to input audio signals into the multi-mode wireless device 104. Sound waves are received by the microphone 228 and are converted into an electrical audio signal. Audio input conditioning circuits 230 receive the audio signal and perform various conditioning functions on the audio signal, for example, noise reduction. An audio input controller 232 receives the conditioned audio signal and sends a representation of the audio signal to the device controller 202.

The multi-mode wireless device 104 also comprises a keyboard 234 for allowing a user to enter information into the multi-mode wireless device 104. The multi-mode wireless device 104 further comprises a camera 236 for allowing a user to capture still images or video images into memory 204. Furthermore, the multi-mode wireless device 104 includes additional user input interfaces 238, for example, touch screen technology (not shown), a joystick (not shown), or a scroll wheel (not shown). In one embodiment, a peripheral interface 240 is included for allowing the connection of a data cable to the multi-mode wireless device 104. In one embodiment of the present invention, the connection of a data cable allows the multi-mode wireless device 104 to be connected to a computer or a printer.

A visual notification (or indication) interface 242 is also included on the multi-mode wireless device 104 for rendering a visual notification (or visual indication), for example, a sequence of colored lights on the display 246 or flashing one ore more LEDs (not shown), to the user of the multi-mode wireless device 104. For example, a received multimedia message may include a sequence of colored lights to be displayed to the user as part of the message. Alternatively, the visual notification interface 242 can be used as an alert by displaying a sequence of colored lights or a single flashing light on the display 246 or LEDs (not shown) when the multi-mode wireless device 104 receives a multimedia message, or the user missed a PTT, PoC or cellular call, or the like.

The multi-mode wireless device 104 also includes a tactile interface 244 for delivering a vibrating media component, tactile alert, or the like. For example, a multimedia message received by the multi-mode wireless device 104, may include a video media component that provides a vibration during playback of the multimedia message. The tactile interface 244, in one embodiment, is used during a silent mode of the multi-mode wireless device 104 to alert the user of an incoming call or message, missed call, or the like. The tactile interface 244 allows this vibration to occur, for example, through a vibrating motor or the like.

The multi-mode wireless device 104 also includes a display 246 for displaying information to the user of the multi-mode wireless device 104 and an optional Global Positioning System (GPS) module 248. The optional GPS module 248 determines the location and/or velocity information of the multi-mode wireless device 104. This module 248 uses the GPS satellite system to determine the location and/or velocity of the multi-mode wireless device 104. Alternative to the GPS module 248, the multi-mode wireless device 104 may include alternative modules for determining the location and/or velocity of multi-mode wireless device 104, for example, using cell tower triangulation and assisted GPS.

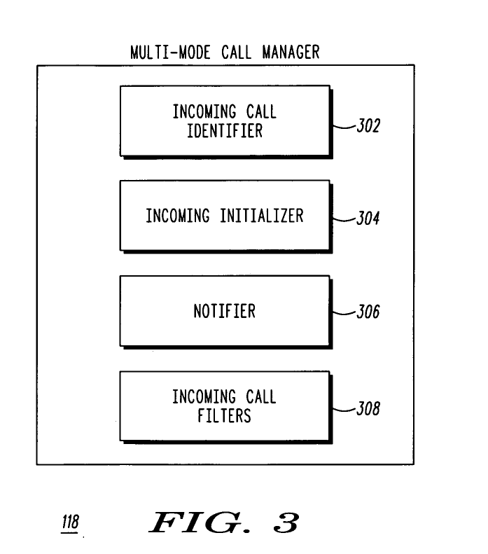

Referring now to FIG. 3 a more detailed view of the multi-mode call manager 118 is illustrated. As discussed above with reference to FIG. 2, the multi-mode call manager 118 allows the user of a multi-mode wireless device 104, 106 currently in a call using at least a first or second communication service to be notified when an incoming call using a different communication service is received. For example, if a user is in a PTT or PoC call and an incoming telephone call is received, the multi-mode call manager 118 notifies the user. Also, the multi-mode call manager notifies the user of a PTT or PoC call being received when the multi-mode wireless device is using a full-duplex communication service such as cellular.

The multi-mode call manager 118 includes an incoming call identifier 302, which identifies when an incoming call is being received at the multi-mode wireless device 104 using a different communication service that what is currently being used or a similar communication service using a different network. The multi-mode call manager 118 also comprises an incoming call initializer 304. The incoming call initializer, in one embodiment, allows the incoming call to be “setup” to the point of ringing so that information such as caller ID can be obtained from the call. This embodiment is exemplary only and the present invention is not limited by this embodiment. If the multi-mode call manager 118 is handling an incoming PTT or PoC call, PTT or PoC call is “setup” so that it can page the multi-mode wireless device 104. Different communication services provide identification data at different times during the call setup. For example, one type of PTT communication service provides caller ID information in the page to the target device. In other types of communication services such as PoC, the caller ID information is retrieved at some point in time after the page.

A notifier 306 is also included that notifies the user of an incoming call associated with a different communication service than what is currently being used. The multi-mode call manager 118 also includes incoming call filters 308. The incoming call filters 308, for example, can be pre-defined or defined by the user. For example, in one embodiment, an incoming call filter 308 is defined for a group of callers/contacts such as personal, business, uncategorized, private, and the like. The incoming call filters 308 use caller ID information of an incoming call and allows for automatic actions to be taken upon a single or group of incoming calls. In another embodiment, the incoming call filters 308 are based on the name of the caller, time, day/date, and/or group ID such as “work”, “home”, “vacation”, “priority”, and/or the like.

The incoming call identifier 302, incoming call initializer 304, notifier 306, and incoming call filters 308 are shown to be residing in the multi-mode call manager 118 in one embodiment. In another embodiment, one or more of these components reside outside of the multi-mode call manager, for example, in the memory 204.

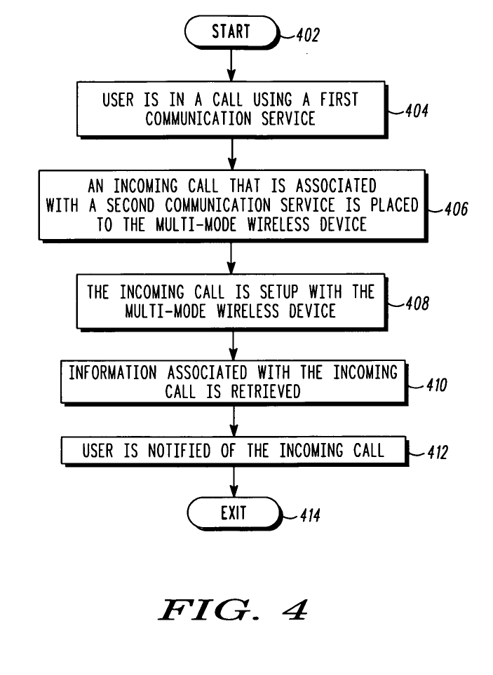

FIG. 4 is an operational flow diagram illustrating an exemplary process of receiving and managing an incoming call associated with a communication service other than the communication service currently being used by the multi-mode wireless device 104. The operational flow diagram of FIG. 4 begins with step 402 and flows directly to step 404. The user of the multi-mode wireless device 104, at step 404, is actively in first communication service such as PTT or PoC. In another embodiment, user is engaged in a second communication service such as cellular. An incoming call that is associated with a different communication service than what the multi-mode wireless device 104 is currently engaged in, at step 406, is placed to the multi-mode wireless device 104. For example, when the communication service currently being used is PTT or PoC, the different communication service is a cellular call or a landline call. When the communication service currently being used is cellular, the different communication service is PTT or PoC.

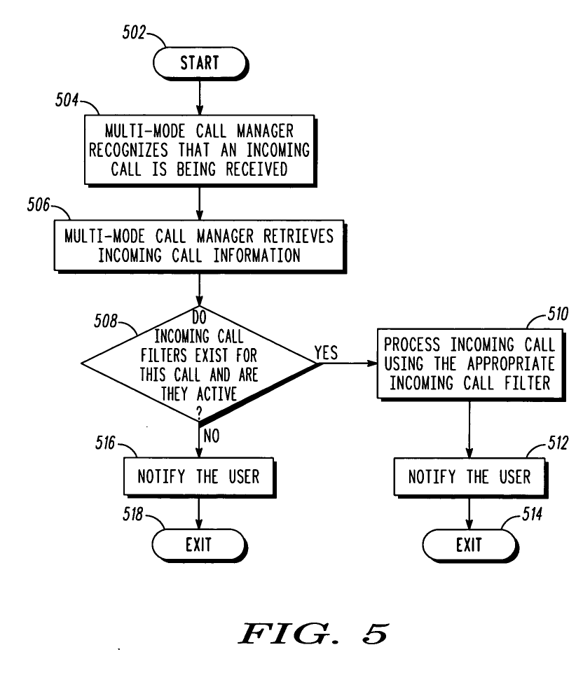

The incoming call, at step 408, is setup with the multi-mode wireless device 104. For example, the incoming call initializer 304 allows an incoming cellular phone/telephone call to ring the multi-mode wireless device 104. In another embodiment where the user is on a cellular call and a PTT or PoC incoming call is received, the PTT/PoC call is setup by allowing the multi-mode wireless device 104 to be paged and respond to the page. The multi-mode call manager 118, at step 410, retrieves the incoming call's information. For example, the caller ID information is retrieved and stored in the memory 204. The retrieved incoming call information, in another embodiment, is stored in the call history database (not shown) ordinarily found in wireless communication devices. The user, at step 412, is notified of the incoming call. For example, the multi-mode call manager 118 can notify the user with a visual alert such as a message on the screen. An audible alert or tactile alert such as vibration can also be used to notify the user of an incoming call. In another embodiment, the multi-mode call manager 118 notifies the user of an incoming call after processing the incoming call according to an incoming call filter (FIG. 5). The control flow then exits at step 414.

FIG. 5 is an operational flow diagram illustrating a more detailed exemplary process of managing an incoming call associated with a different communication service than what is currently being used by the multi-mode wireless device 104. The operational flow diagram of FIG. 5 begins with step 502 and flows directly to step 504. The multi-mode call manager 118, at step 504, recognizes that an incoming call associated with a different communication service is being received. For example, the incoming call identifier 302 signals the multi-mode call manager 118 of an incoming call associated with a different communication service. The multi-mode call manager, at step 506, retrieves the incoming call's information such as the caller ID information. The multi-mode call manager 118, at step 508, determines whether any incoming call filters 308 exist for the incoming call and are active. For example, the multi-mode call manager 118 determines whether an incoming call filter 308 exists associated with the caller ID information of the incoming call.

If the determination at step 508 is positive, the multi-mode call manager 118, at step 510, processes the incoming call using the appropriate incoming call filter 308. For example, the user can have a specific filter 308 for a particular phone number or a category associated with the incoming phone call such as personal, business, or the like. The incoming call filter 308 can be defined to have a variety of functions performed on the incoming call. For example, the incoming call filter 308 can specify that the incoming call be automatically sent to voice mail or automatically have the incoming call put on hold and have a hold message played. Alternatively, in another embodiment, the incoming call filter 308 is defined to let the call go through to the user so that the user can perform a desired action. Once the incoming call is processed according to the appropriate incoming call filter 308, the multi-mode call manager 118, at step. 512, notifies the user that an incoming call was received. The user is notified, for example, while still actively engaged in the current communication service. For example, the multi-mode call manager 118 displays a message on the screen, flashes an LED, creates an audible alert, creates a tactile alert, any combination, or the like. The control flow then exits at step 514. If the determination, at step 508, is negative, the multi-mode call manager 118, at step 516, notifies the user of the incoming call associated with the different communication service by any appropriate notification means. The control flow then exits at step 518.

When the user is currently engaged in a first communication service and the multi-mode call manager 118 notifies the user of an incoming call associated with a second communication service, the user can perform various actions. For example, the user can answer the incoming call and have the current call ended in the background by the multi-mode call manager 118. Alternatively, the user can choose to ignore the incoming call and let the call go to voice mail. The user can also place the incoming call on hold and have an on-hold message played. Additionally, the current call can be placed on hold while the incoming call is answered. In one embodiment, one or more of these actions can be performed by pressing a single key (not shown) on the multi-mode wireless device 104. The present invention is not limited to these actions, as the user can perform additional actions when notified of an incoming call by the multi-mode call manager 118.

An advantage of the present invention is that rather than keeping the user focused on only one call and forcing all incoming calls associated with a different communication service to end up in voice mail or receive a “not available” response, the user can manage these incoming calls. The user, in one embodiment, is notified of an incoming call associated with a second communication service while currently engaged in a first communication service. This allows the user to take an immediate action or speed up the current call so that the incoming call can be answered or quickly returned. Incoming call filters allow the user to further manage incoming calls based on the user's preference.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method on a wireless device for receiving communications associated with a second communication service while actively communicating using a first communication service, the method comprising:
receiving an incoming call associated with a second communication service at a wireless device while actively communication in a first communication service, wherein the second communication service is one of a different communication service than the first communication service or a similar communication service using a different network than the first communication service; and
notifying a user of the wireless device of the incoming call associated with the second communication service.

2. The method of claim 1, further comprising:
setting up the incoming call associated with the second communication service so that information associated with the incoming call is retrievable by the wireless device.

3. The method of claim 1, further comprising:
retrieving information associated with the incoming call to present to the user.

4. The method of claim 1, further comprising:
processing the incoming call associated with the second communication service according to at least one incoming call filter.

5. The method of claim 1, further comprising:
presenting at least one action to be performed on the incoming call associated with the second communication service to the user while the user is currently engaged in the first communication service.

6. The method of claim 5, wherein the at least one action includes:
answering the incoming call associated with the second communication service;
placing the incoming call associated with the second communication service on hold; or
forwarding the incoming call associated with the second communication service to a voice mail system.

7. The method of claim 1, wherein the notifying includes notifying the user by:
a tactile notification;
an audible notification; or
a visual notification;

8. The method of claim 1, wherein the first communication service is a full-duplex communication service and the second communication service is a push-to-talk communication service or a push-to-talk over cellular communication service.

9. The method of claim 1, where the first communication service is a push-to-talk communication service or a push-to-talk over cellular communication service and the second communication service is a full-duplex communication service.

10. A wireless device for receiving communications associated with a second communication service while actively communicating using a first communication service, the wireless device comprising:
a memory;
a device controller electrically coupled to the memory;
at least one receiver for receiving a first communication associated with a first communication service and second communication associated with a second communication service; and
a multi-mode communications manager communicatively coupled to the device controller for managing an incoming communication associated with the second communication service while a user is actively using the first communication service, the multi-mode call manager comprising;
an incoming communication identifier, wherein the incoming communication identifier identifies the incoming communication associated with the second communication service when the user is actively using the first communication service; and
a notifier for notifying the user of the incoming communication associated with the second communication service when the user is actively using the first communication service.

11. The wireless device of claim 10, further comprising:
an incoming communication initializer for initializing the incoming communication associated with the second communication service so that information associated with the incoming communication is retrievable by the multi-mode communications manager.

12. The wireless device of claim 11, wherein the multi-mode communications manager retrieves caller ID information associated with the incoming communication associated with the second communication service.

13. The wireless device of claim 10, wherein the multi-mode communications manager further comprises:
at least one incoming communication filter, wherein the multi-mode communications manager processes the incoming communication associated with the second communication service according to the at least one incoming call filter.

14. The wireless device of claim 10, wherein the multi-mode communications manager presents at least one action to be performed on the incoming communication associated with the second communication service to the user while the user is currently engaged in the first communication service.

15. The wireless device of claim 14, wherein the at least one action includes:
answering the incoming communication associated with the second communication service;
placing the incoming communication associated with the second communication service on hold; or
forwarding the incoming communication associated with the second communication service to a voice mail system.

16. The wireless device of claim 10, wherein the notifier notifies the user by at:
a tactile notification;
an audible notification; or
a visual notification;

17. The wireless device of claim 10, wherein the first communication service is a full-duplex communication service and the second communication service is a push-to-talk communication service or a push-to-talk over cellular communication service.

18. The wireless device of claim 10, wherein the first communication service is a push-to-talk communication service or a push-to-talk over cellular communication service and the second communication service is a full-duplex communication service.

19. The wireless device of claim 10, wherein the second communication is a data communication.

20. The wireless device of claim 10, wherein the second communication service is one of a different communication service than the first communication server or is a similar communication service using a different network than the first communication service.
